(19) United States
(12) Patent Application Publication
(10) Pub. No.: US 2025/0298841 A1
(43) Pub. Date: Sep. 25, 2025

(54) Enhanced Auditioning System

(71) Applicant: Erika McFadden, East Islip, NY (US)

(72) Inventor: Erika McFadden, East Islip, NY (US)

(21) Appl. No.: 19/197,858

(22) Filed: May 2, 2025

Related U.S. Application Data
(63) Continuation-in-part of application No. 18/387,844, filed on Nov. 7, 2023.

(51) Int. Cl. G06F 16/74; G06F 16/71; G06F 16/78

(52) U.S. Cl. CPC G06F 16/743; G06F 16/71; G06F 16/7867

(57) ABSTRACT

A system and method includes a software application for enabling matching of casting roles within the performing arts sector with potential acting talent, wherein the software application provides individual facilities to a plurality of casting directors, utilizing their own casting portions exposed to them by the software application to create casting roles, where a backend component publishes the casting roles to actors engaging the software application via an acting component that is exposed by the software application individually to each actor, where the software application provides an artificial intelligence component that is used as a casting partner to responsively reply to the audition of the audition, where the artificial intelligence component can also be used by the software application to assess or make recommendations regarding the audition results, and where the software application is further configured to contain security features to guard against data tampering.

### CROSS REFERENCE TO RELATED APPLICATIONS

This application is a continuation-in-part of U.S. application Ser. No. 18/387,844 filed Nov. 7, 2023, the content of which is incorporated herein by reference in its entirety.

### BACKGROUND OF THE INVENTION

### 1. Field of the Invention

The present invention relates to identifying talent in the performing art industry and, more particularly, to a system and method for connecting or matching talent with available openings.

### 2. Description of the Related Art

In the world of entertainment, whether it be theater, film, television, or other performing arts, the process of identifying, auditioning, and selecting actors for specific roles has traditionally been a complex and time-consuming task. Producers and casting directors often grapple with a myriad of challenges to identify the right talent to bring their creative visions to life. These challenges include managing logistics, efficiently coordinating auditions, and ensuring the authenticity of the performance of the actors during the audition process.

The traditional casting process is typically complex, and begins with role identification, where producers and casting directors identify the roles required for a production and create detailed casting descriptions, outlining the characteristics and qualities being sought in actors. A casting team then communicates with talent agents to relay role descriptions and requirements, a process that can be prone to miscommunication or delays.

Agents subsequently engage with actors to advise them of available casting opportunities, often involving cumbersome scheduling and coordination. Actors are called to in-person auditions where they perform in front of the casting team. This process can be both costly and time-consuming, especially for actors who may have to travel long distances to audition. In some cases, actors may misrepresent their qualifications or credentials during auditions, leading to suboptimal casting decisions and potential financial and logistical setbacks.

Perhaps the biggest factor that keeps the auditioning process a face-to-face affair is the need to monitor auditioning processes to prevent forgeries, fakes and tampering. Often the stakes involved in landing a role are high and the competition for available roles is fierce, which motivates contestants to cheat or use other underhanded ways to obtain unfair advantages. Therefore, on the one hand, while remote auditioning has opened more venues and opportunities to both actors and producers, difficulties in preventing and detecting cheating have hampered the adoption of remote auditioning, on the other hand.

Additionally, conventional solutions only address portions of the process. Auditions are generally manual or in-person events, and assembly and editing of casting roles is performed manually or via the use of “off the shelf” tools, often resulting in “one-off” manuscripts with all other participants working on their own copies of files. There is very little collaborative process between the different participants in the role casting or between actor and publisher of the role. Therefore, it is highly desirable to have a computer enabled tool that will provide common collaboration tools, communication tools, project management tools and talent development and research tools all under one umbrella.

### SUMMARY OF THE INVENTION

Disclosed is a computer-based system configured to match artistic talent with open casting roles that are being filled by casting producers, which includes a computer application comprising at least three portions, i.e., a casting portion, an actor portion and a backend portion. The casting portion is made available to a casting director or producer who serves as the publisher, defining in the casting portion, one or more casting roles along with criteria for the casting role or the talent sought to fill this casting role.

The actor portion is made available to actors, or those seeking opportunities presented by the casting roles published through the casting portion. The actor portion provides an actor with a way to submit their credentials. The disclosed actor portion provides an auditioning platform that an actor may utilize to remotely audition for a casting role. This means that rather than needing to be present with the casting director at the casting site, an actor may be within the comfort and confines of his or her home when auditioning for the casting role. The credentials of an actor form actor data, while the audition of the actor creates audition data. Together, audition data and actor data are then supplied by the backend portion to the casting portion if the audition data and/or actor data fulfill the requirements mandated by the casting director for the casting role.

In one embodiment, the auditioning platform provides the tools an actor will need to train for the audition and then record him or herself performing the audition. If the credentials of the actor and audition criteria specified by the publisher of the role for which the actor is auditioning, then the audition data of the actor will be presented to the publisher for consideration, along with any other actors auditioning for the casting role.

The relationship between the casting portion and the actor portion is managed by the backend portion. The backend portion of the software application receives the casting roles from the publisher, and develops the audition process required to collect the audition data. The The backend portion of the software application thus provides the auditioning computer infrastructure or environment to an actor to make remote auditing possible, and then stores auditing data to either be presented to the publisher, reviewed for future opportunities and roles, or discarded.

It is preferable that the auditioning platform and or the backend portion processes are configured to have an artificial intelligence component. The artificial intelligence component is configured to provide a responsive conversation with an actor auditioning for a role, as well as to record nuances that would not normally be detectable in a live performance or without the artificial intelligence component (“AIC”).

In another embodiment, the AIC may be further configured to provide casting and audition editing recommendations or a matching recommendation linking at least one casting role with at least one actor. The AIC is configured to render recommendations based on whether the actor data and/or the auditioning data correspond to the criteria of the role that is the subject of the audition. The backend portion then publishes to the casting portion of the publisher, all of the auditioning data and actor data found to correspond to publisher's criteria for the role or roles the publisher is looking to fill.

In another embodiment, the AIC is configured to produce auditioning data and/or actor data to the dashboard of the casting portion by combining recent auditioning data, or data specifically compiled for the specific casting role, or based on a library of prior auditions for other roles, where auditioning data and/or actor data for an actor is stored in an accessible library within the backend portion, and which is searchable by the publisher to be produced at the publisher's dashboard of the casting portion

The disclosed inventive system enables the implementation of a method for filling character roles in the preforming arts comprising providing by the backend portion of the software application the casting portion to at least one publisher; followed by or concurrently with providing by the backend portion of the software application an actor portion to at least one actor. The publisher utilizes the casting portion to publish at least one casting role that requires auditions from a potential pool of actors competing for this casting role.

The casting role is then published by the backend potion to a plurality of actors, who receive the acting portion of the application available to them. The actor will then utilize auditioning infrastructure of the acting portion to record his or her own audition using equipment available to the actor at home, or wherever the actor is located, which may be a computer a mobile phone or more advanced sound and video equipment. The audition is is then stored as auditioning data by the backend portion.

The backend portion then links descriptive criteria about the actor, or actor data, with the audition of the actor for the role or auditioning data. The audition and/or actor data is then compared against the casting role provided by the publisher and/or the criteria for the casting role. The comparison, as well as recommendations of the disclosed method, may be accomplished by the application with the actor data of the actor, where the auditioning data and the actor data are provided to the backend portion, the backend portion determines which of a plurality of the auditioning data and the actor data from the plurality of actors corresponds to the casting role, where the backend portion presents a set of audition data and actor data to the at least one publisher via the casting portion, the set of audition data and actor data corresponding to the at least one casting role.

In one embodiment, the disclosed method allows the publisher to add or modify criteria for any casting role.

In preferred embodiments, the inventive method uses an artificial intelligence component (AIC) at the actor portion to assist the actor with his or her audition. One of several ways by which the AIC assists in conducting an auction is by replicating an in person auditioning experience with an interactive experience. For example, the AIC provides a second or third person, and or narrator of a scene for which an actor as auditioning. As the actor recites and act his or her lines during the audition, the AIC responds to the actor by impersonating a character with whom the actor is conversing, or impersonates the narrator between scenes or as a background.

The backend portion with or without the AIC then integrates security and authenticity data to the audition and actor data to prevent tampering. The addition of anti-tampering features is preferably always engaged to prevent impersonation, substitution, overwrite and other deep fake methods that may be utilized by someone subscribing to the actor portion.

In an additional preferred embodiment, the AIC compares the casting role to a plurality of auditioning and/or actor data to identify a match or a close resembling relationship between the casting role and a criteria for the casting role and the audition and/or acting data. Once the match or close resemblance is identified, the data or a set of audition and actor data is presented to the publisher of the casting role at the casting portion of the computer application.

It should be noted that the backend portion is preferably an offered subscription service to the publisher and actors, who upon creating their profiles, receive the software environment constituting either the casting portion, which a casting producer will utilize to publish roles and review applicants and their auditions, or the acting portion, which an actor will utilize to review published casting roles based on the criteria for the actor for the roles and audition for desired roles by utilizing the AIC to first train for the role then record an audition for the role.

It is important to note that just like the casting director, an actor desires to be assured that the recorded audition will not be tampered with or impaired between its recording and its viewing by the publisher. Therefore, the tampering protection disclosed by the inventive system and method are intended to serve both the publisher and the actor.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which they are achieved will become clearer and more readily comprehensible in connection with the following description of exemplary embodiments, which are explained in greater detail in connection with the drawings, in which:

FIG. 1 is a schematic block diagram illustrating components of an inventive enhanced auditioning system;

FIG. 2 is a flowchart illustrating an inventive method for managing remote auditions;

FIG. 3 illustrates the basic security features of the computer application in accordance with the invention;

FIGS. 4 and 5 is a flowchart illustrating an embodiment of the inventive method;

FIGS. 6A, 6B and 7 illustrate a dashboard exposed by the application process to each publisher, although each publisher receives access to their individual dashboard;

FIG. 8 is an illustration of the auditioning platform; and

FIG. 9 is an illustration of an auditioning screen displayed after an actor has learned his or her lines.

### DETAILED DESCRIPTION OF THE EXEMPLARY EMBODIMENTS

The preferred embodiments of the present invention will now be described with reference to the drawings. Identical elements in the various figures are identified with the same reference numerals. Such embodiments are provided by way of explanation of the present invention, which is not intended to be limited thereto. In fact, those of ordinary skill in the art may appreciate upon reading the present specification and viewing the present drawings that various modifications and variations can be made thereto.

A blockchain-based, decentralized enhanced auditioning system may be used to manage tasks associated with the casting process for the film and television industry. As disclosed herein, the platform streamlines audition script distribution, video submissions, and review processes while fostering collaboration among key stakeholders.

The disclosed auditioning system provides several benefits:
1. Blockchain technology and encryption protect sensitive audition scripts and video submissions from unauthorized access and data breaches, delivering a level of security that conventional casting platforms cannot match.
2. Transparency is provided through blockchain recording, role-based access control, and the ability to grant or revoke access to specific stakeholders based on predefined user roles and permissions. This transparent approach offers a level of accountability and trust that is lacking in traditional casting platforms.
3. A comprehensive suite of tools for casting directors to manage audition invitations, scheduling, and outcomes, alongside a user-friendly interface for reviewing, commenting on, and rating audition videos. This seamless approach facilitates efficient decision-making and enhances collaboration among stakeholders, providing a significant improvement over existing casting solutions.
4. A complete platform eliminates the need for integration with other casting tools or software. The disclose method and system provides a complete casting solution that simplifies and consolidates the casting process, reducing complexity, potential compatibility issues, and reliance on multiple systems that plague traditional casting methods.
5. Cutting-edge features, such as encrypted script distribution, role-based access control, secure video submissions and storage, and efficient audition management, set the inventive system and method apart from existing casting solutions, offering a more advanced and user-friendly experience for industry professionals.
6. The platform or system accommodates evolving needs of the film and television industry, making it an ideal long-term solution for movie studios and TV networks looking to stay ahead of industry trends and challenges. This adaptability provides an advantage over traditional casting solutions that may struggle to adapt to the ever-changing industry landscape.

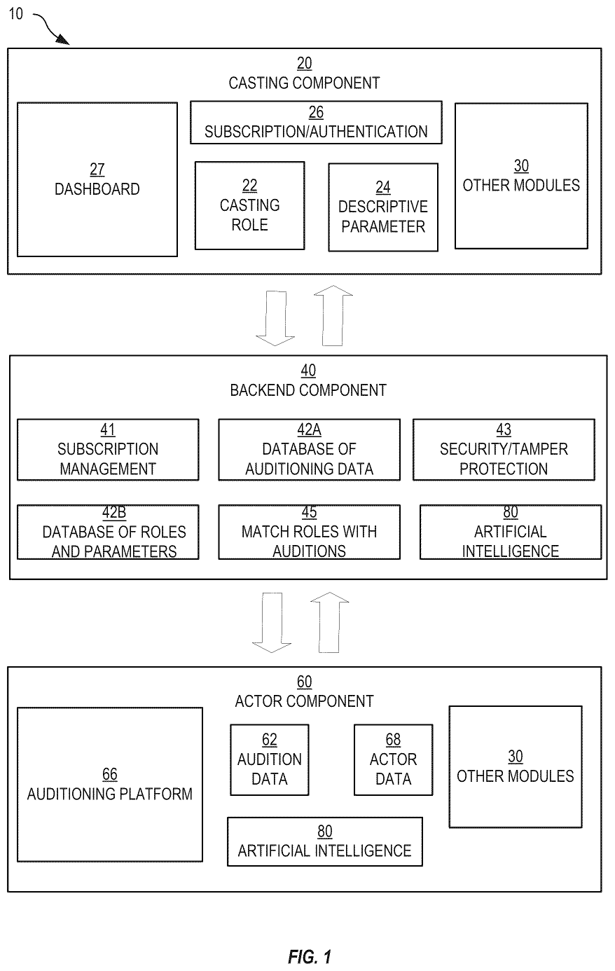

FIG. 1 is a block diagram illustrating components of an enhanced inventive auditioning system 10.

System 10 provides a decentralized platform for matching artistic talent with open roles. In disclosed embodiments, system 10 is illustrated as three main components, although any of the functions described therein may be split into more than three components, or combined differently than disclosed herein. The three components in FIG. 1 include casting component 20, backend component 40 and actor component 60. The three components of system 10 are in data coordination relationship with each other, i.e., the data created in the casting component 20 is the data viewed at the actor component 40 and at the back component 60. Alternatively, the data created in any component may be replicated at the destination component.

Casting component 20 is configured to allow the creation of at least one casting role 22. With further reference to FIG. 1, the publisher is the user of the casting portion 20. The publisher represents the casting director or producer within the performing arts environment. The publisher also preferably utilizes the casting role 22 to define one or more descriptive parameters 24 associated with each casting role 22. The descriptive parameters 24 may comprise, but is not limited to the gender, age, height, weight, skin color and voice of an ideal candidate. Descriptive parameters 24 may additionally define the experience of a candidate, the location of the actor with respect to the production location, travel requirements, compensation expectations and many other factors. It should be understood that the roles 22, the descriptive parameters 24, the subscription/authentication 26 of the publisher are elements of the database 42 that are exposed or exported to the casting portion 20 to be used by this specific publisher. At any one time, a plurality of publishers may each utilize their individual casting portions 20, with all such casting portions 20 being isolated from each other.

Dashboard 27 of casting component 20 displays information and menus that may be used by a publisher to create casting roles, enter parameters and view audition data 62 including a list of videos created by actors auditioning for casting roles 22, for example.

Videos may be created by actors using actor component 60, as will be described in more detail below. Actor data 68 may be part of an account associated with an actor for storing contact information and descriptive parameters 24 for the individual actor for use in matching actors to casting roles 22. Audition data 62 represents one or more videos recorded by an actor using auditioning platform 66. Auditioning platform 66 is preferably a set of sub-tools made available by the system 10 to each actor/performer attempting to audition for a role. It should be noted that casting role 22 may be a stage role, a role in a film or any entertainment function requiring a performance of some sort, such as a magician, musician, acrobat, daredevil, or trapeze walker. Possible sub-tools may include, but are not limited to, a voice recorder, a sound recorder, a video recorder, recording editor and other minor controls of these features. The auditioning platform 66 is intended to both train the actor in the character expected by the role being cast, and to provide the medium to record the actual audition.

Backend component 40 is configured to facilitate interaction between a publisher and an actor, as well as other users of the system, such as an agent. In particular, backend component 40 may include the function of associating casting role 22 with the criteria of the descriptive parameters 24 for each casting role 22. It should be noted the backend component 60 enables the auditioning platform 66 for each or performer/actor. The backend component 40 then utilizes the actor component 60 to collect personal actor data 68 and associate it with an audition data 62 for each actor within actor component 60. The backend component 40 then assembles the audition data 62 and actor data 68 from all performers that satisfy the criteria of the descriptive parameters 24 and casting role 22 and are presented at the dashboard 27. It should be further noted that the auditioning platform 66 is configured to function as a dashboard for the actor to view and search for available roles and view feedback. The dashboard 27 for the actor is preferably populated using data from database 68 of the backend component 60.

System 10 also includes artificial intelligence component 80. Portions of artificial intelligence component 80 may be incorporated in any component of system 10 to assist in conducting auditions by a performer. Here, the artificial intelligence component 80 is shown within the backend component 40 and the actor component 80 for purposes of illustration. During an audition, the artificial intelligence component 80 may function as a responding character to the roles being performed by the auditioning actor. By way of example, a performer auditioning for the role of a first character in a scene in which the first character converses with a second character, the artificial intelligence component 80 performs the part of the second character, responding to the lines of the first character when spoken by the actor. Artificial intelligence component 80 may respond as a plurality of second characters and provide realistic effects, such as a digital representation of the second characters. Additionally, a publisher may configure the artificial intelligence component 80 to intentionally interfere or send exterior stimuli that would mimic events in the context of a live scene.

Artificial intelligence component 80 may fulfill other functions in the actor component 60. During an audition, the artificial intelligence component 80 may monitor the delivery of a role by a performer, the response to a stimulus, the ease of presentation and quality of delivery of verbal lines, voice intonations and body gestures. Artificial intelligence component 80 may provide comparisons to other performers. Additionally, artificial intelligence component 80 may be utilized to replicate one or more than one role at a time in response to the lines provided by a performer. Actor component 60 may be configured to permit the actor to record scenes out of sequence, or to proceed to specific point in a script, such as at a particular location during presentation, or may be configured by the publisher to permit auditions only during particular times of the day week or calendar day. Additionally, the artificial intelligence component 80 may be used to enhance the data integrity of the auditions by detecting improper access or editing. The backend portion 40 preferably disclose additional modules, such as a subscription management 41, the database 42A of audition data 62 and actor data 68 and database of roles and parameters 42B created by publishers. Alternatively, databases 42A and 42B may be combined in a single database. Also shown is a security/tamper protection module 43, which provides secure isolation between casting component 20 and actor component 60 of each actor and publisher, as well as data integrity and protection of the role data, actor data and auditioning data from tampering.

Any of the backend component 40, the casting component 20 and the acting component 60 may include other modules 30, such as a communication module for private emailing or texting from within the application, text editing and collaboration tools to edit or otherwise process data associated with the casting role 22, auditioning data 62 or actor data 68, a project management module (not shown) to treat the casting of a role to filing it as a project. Additional modules that may be possible may support training of actors or proactive actor searches by publishers/casting directors, to identify candidates based on prior experience, schooling or other information available in the library included in backend component 40.

### EPIC 1—User Registration, Authentication, Authorization, Homepages/Dashboards, User Profile Management

System 10 provides a number of modules to facilitate interaction between multiple users, and between users and the system 10. A representative sample of these modules will be described, but additional modules may be included that would be useful in facilitating an enhanced auditioning process and interactions between users responsible for different aspects of producing performance involving actors. Descriptions herein will refer to user roles including actors, parent/legal guardian of an actor, agents, casting directors and producers. Other roles may be contemplated.

System 10 is a decentralized platform that may be accessed through a landing page on a website, for example. The landing page explains the purpose and benefits of the platform, explores its features, and easily navigates to relevant sections or provides sign up/sign in as a user. Aspects of a landing page may include a Welcome Message, Platform Overview, About the Company, Sign-up/Sign-in options, Contact Information, FAQ sections.

Users of system 10 will register and create an account, regardless of their role. A representative account creation process for an actor may include:
Click the ‘Register’ button.
Choose the role of ‘Talent’.
Create a username and password.
Choose a plan (Free, Pro, Premium, etc.)
Enter email and other contact information.
Enter valid values to all mandatory Personal Info fields that form the basis of descriptive parameters 24.
Agree to the Terms of Service and Privacy Policy.

The account creation process may also include an email confirmation process as well as tools to edit/update any of the entered information.

The account creation process is similar for other roles with a few variations. For example, a parent/legal guardian may be asked to check a box verifying “I am a Parent of Legal Guardian registering on behalf of a minor.”

The account creation process for an agent may request additional information, such as agency name and address, and a list of actors represented by the agent. An agent profile may also include information such as areas of expertise, availability and experience.

The account creation process for a casting director or producer may request information such as a company/production name instead of an agency name. The profile for a casting director or producer may also include information such as areas of expertise, availability and casting or producing credits.

Once an account is created, any user may log in to their account and use the system 10. After logging in, each user is provided with a personalized homepage/dashboard that will facilitate the user interactions with the system 10. This dashboard may differ depending on the user role.

For example, an actor dashboard may include a list of auditioning scripts that include a character matching the actor's parameters, upcoming auditions, offers and contracts. An agent dashboard may include a list of actors represented by the agent, a list of active submissions by represented actors, as well as offers and contracts. A casting director dashboard may include projects, unreviewed submissions, upcoming auditions, unreviewed audition videos, offers and contracts. A producer dashboard may include information similar to that of the casting director dashboard.

The profile of an actor may include a wide variety of parameters that could be considered by a casting director or producer. A representative list includes:
1. Summary
1.1. Personal info such as Profile photo and Resume, First and Last Name, Stage Name, Birth Date/Age, Union Status, Main working location, Email, Phone
1.2. Physical Attributes such as Playable Age Range, Gender, Ethnic Appearance, Height, Weight, Build, Hair Length & Style, Eyes, Piercings, Tattoos, Other Body
1.3. Social Media
1.4. Short Bio
1.5. Consents to nudity and other types of controversial content.
2. Media including videos and still shots
3. Size Card including measurements
4. Skills and Abilities
1. Acting Techniques: Stanislavski System, Method Acting, Meisner Technique, Practical Aesthetics, Viewpoints, Grotowski's Poor Theatre, Suzuki Method, Commedia dell'Arte, Laban Movement Analysis, Shakespearean Acting Techniques.
2. Emotional Range: Joy, Sadness, Anger, Fear, Love, Surprise, Disgust, Anticipation, Excitement, Happiness, Grief, Frustration, Anxiety, Jealousy, Envy, Guilt, Shame, Pride, Hope, Compassion, Empathy, Sympathy, Nervousness, Confusion, Disappointment, Regret, Contentment, Relief, Curiosity, Awe, Boredom, Satisfaction, Gratitude, Trust, Surprise, Loneliness, Tenderness, Contempt, Despair, Doubt, Discomfort, Embarrassment, Excitement, Jealousy, Remorse, Tension, Resentment, Amusement, Irritation, Elation.
3. Vocal and Singing Abilities: Soprano, Mezzo-soprano, Contralto, Tenor, Baritone, Bass.
4. Dancing: Ballet, Jazz, Contemporary, Hip-Hop, Tap, Latin, Ballroom, Flamenco, Bollywood, Contemporary Ballet.
5. Musical instruments: Guitar (acoustic, electric, bass), Violin, Viola, Cello, Double Bass, Harp, Ukulele, Banjo, Flute, Clarinet, Oboe, Bassoon, Saxophone, Trumpet, Trombone, French Horn, Tuba, Cornet, Drum Kit, Snare Drum, Bass Drum, Cymbals, Tambourine, Xylophone, Marimba, Timpani, Bongos, Congas, Djembe, Piano, Organ, Electric Keyboard, Synthesizer, Accordion, Electric Guitar, Electric Bass, Digital Piano, Drum Machine, Sampler, MIDI Controller, Bagpipes, Didgeridoo, Theremin, Harmonica, Sitar, Steel Pan, Kalimba, Native American Flute, Shakuhachi.
6. Fluent Languages: Mandarin Chinese, Spanish, English, Hindi, Arabic, Bengali, Portuguese, Ukrainian, Japanese, German, French, Korean, Russian, Italian, Turkish, Dutch, Swahili, Polish, Vietnamese, Thai, Greek.
7. Dialects:
British English dialects: Cockney (British), Geordie (British), Scouse (British) American English dialects: Southern (American), New York (American), Boston (American), Appalachian (American), and African American Vernacular English (American) German dialects: Bavarian (German), Swiss German (German), Low German (German) Italian dialects: Tuscany (Italian), Sicily (Italian), Veneto (Italian) Chinese dialects: Mandarin (Chinese), Cantonese (Chinese), Wu (Chinese), Hakka (Chinese).
8. Accents: Received Pronunciation, General American, French, Indian, Scottish, Australian.
9. Physical Skills: Strength, Power, Endurance, Flexibility, Coordination, Motor, Agility, Balance, Reaction, Spatial Awareness, Proprioception.
10. Sports Addictions: Soccer, Football, Basketball, Baseball, American Football, Rugby, Ice hockey, Field hockey, Volleyball, Cricket, Handball, Tennis, Golf, Athletics, Swimming, Gymnastics, Boxing, Cycling, Skiing, Cross-country skiing, Figure Skating, Boxing, MMA, Judo, Karate, Taekwondo, Wrestling, Fencing, Muay Thai, Brazilian Jiu-Jitsu, Swimming, Surfing, Rowing, Sailing, Water Polo, Diving, Canoeing and Kayaking, Badminton, Squash, Table Tennis, Racquetball, Skateboarding, Snowboarding, BMX, Rock Climbing, Skydiving, Bungee Jumping, Parkour, Archery, Shooting, Darts, Billiards, Bowling, Formula 1 Racing, MotoGP, Rally Racing, NASCAR, Motocross, Drag Racing.
11. Driving, Boating & Piloting: 4WD, ATV, Airplane, Boat, Canoeing, Dune Buggy, Helicopter, Hot Air Balloon, Jet Skiing, Kayaking, Kite Surfing, Motorboat, Motorcycle, Paddle Boarding, Rafting, Road Driving, Rowing, Sailing, Sculling, Semi-Truck, Snowmobile, Stick Shift, Track Driving.
12. Stunts: Air Rams, Break Falls, Breakaways, Building Falls, Car Hits, Creature Suit Work, Full Fire Burns, High Falls Above 50′, High Falls Below 50′, Horse Falls, Partial Fire Burns, Pratfalls, Precision Driving, Ratchets, Saddle Falls, Squib Hits, Stage Combat, Stair Falls, Wire Work.
13. Weapons & Firearms: Automatic Weapon, Bo Staff, Broadsword, Cross Bow, Daggers, Handgun, Kama, Long Bow, Nunchucks, Rapier, Rifle, Sai, Shotgun, Staff, Swords, Throwing Knives, Throwing Stars, Tonfa, Whip.
14. Military: Air Force, Army, Coast Guard, Marines, National Guard, Navy, Navy Seals, R.O.T.C., Royal Air Force, Special Forces.
15. Hobbies: Reading, Writing, Drawing and Painting, Photography, Cooking and Baking, Gardening, Sports and Physical Activities, Music, Gaming, Collecting, DIY and Crafting, Technology and Coding, Traveling, Film and TV, Volunteering, Fitness, Dancing, Language Learning, Science and Nature, Mind Games, Camping, Fashion.
16. Jobs: Accountant, Architect, Barista, Bartender, Biologist, Chef, Civil Engineer, Content Writer, Data Analyst, Dentist, Doctor, Electrician, Event Planner, Fashion Designer, Firefighter, Fitness Trainer, Flight Attendant, Graphic Designer, Human Resources Manager, Interior Designer, Journalist, Landscape Architect, Lawyer, Librarian, Marketing Manager, Mechanic, Nurse, Nutritionist, Paramedic, Pharmacist, Photographer, Police Officer, Project Manager, Psychologist, Real Estate Agent, Research Scientist, Software Developer, Social Worker, Teacher, Translator, Truck Driver, UX/UI Designer, Veterinarian, Waiter/Waitress, Web Developer, Zoologist.
5. Acting Experience including Project Title, Period, Type, Project Description.
6. Additional Info such as Unique Attributes & Conditions, the use of Assistive Devices, Twins/Multiples, Pregnancy, Limitations & Phobia.

### EPIC 2—Project Creation, Adding a Team to a Project, Role Breakdown

As described above with respect to FIG. 1, casting component 20 includes a dashboard 27 that may be accessed by user roles to perform tasks associated with that user role.

The menu items, or tasks, available to a casting director may include, for example, creating a new project including parameters, such as project name, project creation date, active roles, project type, franchise, project union, production company and project description. Another menu item may include a Teams list of those involved in a particular project. Dashboard 27 facilitates adding one or more team members to one or more projects. Team members may include any of the user roles such as Actor, Manager, Casting Director or Producer. Dashboard 27 may include a Role Breakdown that shows details of actors who match a role and actors who will or will not be allowed to submit an audition for a role, as well as other details.

The tasks available to an agent may include a project list so that projects and recent activities involving actors represented by that agent may be tracked. Agents may also be able to access information about actors who have been matched with a role, actors who have received an offer, and other information associated with matching an actor to a role.

Any user of dashboard 27 may update profile and account information.

### EPIC 3—Talent Selection Flow, Matching Algorithm

System 10 may be used to manage submissions, auditions and callbacks for any of the user roles.

For actors, system 10 may facilitate tasks involved with submissions by allowing an actor to enter photos and other information as described in more detail below, and by providing a list of active auditions submitted by an actor. Actors may facilitate tasks involved with auditions that may be categorized as self-tape, in-person or virtual. Actors may also view callback invitations concerning auditions that have been submitted.

For agents, system 10 may provide a list of submissions by actors represented by the agent. The list may be organized by actor or any other criteria. Agents may receive notification of available auditions from casting directors and view a list of actors invited to audition. Agents may also view callback invitations concerning auditions that have been submitted.

For a casting director, system 10 may provide a list of submissions by actors. The list may be organized by actor, project, or any other criteria. Casting directors can access additional details about an actor, as well as issue a further invitation or decline the actor's services. Casting directors may view audition invitations that have been issued and/or accepted. Casting directors may also view callback invitations concerning auditions that have been submitted.

### Matching Algorithms

System 10 provides a robust matching algorithm for roles and actors to efficiently identify the most suitable actors for each role based on their skills and attributes.

The algorithm may include quantitative matching of physical attributes, skills and abilities, additional info, and consents to special situations. The algorithm generates a list of ranked actors for each role, with the highest-ranked actors being the most suitable based on the given criteria (Casting Director's Dashboard functionality). System 10 displays a list of matched roles for each actor, ranked by relevance based on the provided criteria, and provides detailed information about each role (Actor's Dashboard functionality). System 10 provides a list of ranked actors represented by the agent for each role, with the highest-ranked actors being the most suitable based on the given criteria (Agent's Dashboard functionality). The matching algorithm continuously updates and reevaluates the matches as new actors and roles are added to the system 10, ensuring that the matches or opportunities presented remain current.

### EPIC 4—Offers & Contracts

System 10 allows users to perform tasks associated with offers and contracts. A user can access details regarding offers including status as pending, accepted, revoked and change request. Details regarding the project and role associated with the offer may also be viewed. Other information typically included, such as approximate work dates, rate, billing, travel, hotel accommodations, ground transportation, dressing room, per diem and travel allowance, may also be provided. Actors may accept an offer and/or request changes to the offer.

System 10 may facilitate access to contract details similar to those listed for offers. Offers and contracts may be viewed by any user with permission to do so.

### EPIC 5—Task Management System

System 10 allows users to perform a variety of task management functions, such as viewing a list of tasks, creating and editing tasks, marking a task as complete, reopening a task, adding comments to a task and tagging team members. Other functions are contemplated.

### EPIC 6—Calendar (Scheduling and Availability)

System 10 provides for tasks associated with scheduling and availability. For example, actors may manage their availability, schedule auditions, callbacks, and meetings directly within system 10, with reminders and notifications including cancellation of participation and rescheduling requests. Agents may perform tasks associated with bookings, engagements, availability, and scheduling management such as creating new bookings, specifying event details, dates, and requirements, marking unavailable dates, and viewing upcoming and past engagements. Casting directors may view casting sessions, participants list, schedule and calendar. Producers may create and manage projects, including budgeting, scheduling and team collaboration.

### EPIC 7—Virtual Auditions and Callbacks

Casting Director can host virtual auditions and callbacks for actors who have been invited and have confirmed their participation, so that their performances may be evaluated in real-time to make informed casting decisions. Actors can participate in virtual auditions and callbacks for roles to which they are invited to and have confirmed.

Unique and secure links for virtual audition/callback sessions and meetings may be automatically generated. Casting Directors and other team member can assign/add team members to virtual audition during role creation or editing using a pre-meeting room for virtual auditions. Team members may be added to a virtual audition when a casting director is creating or editing a role and specific virtual audition, to ensure all necessary team members are involved in the audition process and have access to the session.

Once a Casting Director creates a pre-meeting room for virtual auditions, actors may prepare for a virtual audition in the pre-meeting room, where they can manage camera and microphone settings, evaluate their appearance, and see the number of active actors ahead of them in the waiting room, so that they can prepare myself effectively before my audition begins.

Casting Directors control video conference and participant access including starting and ending the video conference, controlling the joining and disconnecting of actors and team members, and managing audio/video settings, so that they can efficiently manage the audition process and ensure smooth communication.

Actors can join a video conference room and participate in a virtual audition/callback, which can be recorded for later review. A unique virtual audition or callback session link may be verified in real-time when accessing the session to ensure the security of the audition and reduce the risk of unauthorized access or brute-force attacks.

Dynamic watermarking may be used for video streams and recordings. Dynamic watermarks (e.g., showing the name of the actor (participant), role, and a company logo) may be automatically applied on both live video streams and recorded videos, so that the content is securely protected, easily traceable, and branded. Agora supports watermarking for both live video streams and recorded videos. Watermarks can be added to video streams by configuring the WatermarkOptions class in the Agora Video SDK. This allows for the inclusion of images or text as overlays on the video, which can be customized in terms of position, size, and visibility.

### EPIC 8 and 8.1—Video Annotations & Markup Tools

System 10 provides a set of video annotations and mark-up tools that support self-tape auditions, rehearsals, and live auditions—whether conducted virtually or through pre-recorded submissions. The system 10 provides an interactive and collaborative environment for casting directors, agents, producers, and other stakeholders to securely review, annotate, and provide feedback on audition footage. The system additionally enables users to organize and segment tapes by scene and actor name, ensuring a streamlined, verifiable, and efficient evaluation process. The annotation tools facilitate a transparent and collaborative review cycle, helping to accelerate casting decisions and enhance the overall audition workflow.

The Annotations and Visual Markup feature allows reviewers to leave precise, time-stamped comments directly on audition videos or rehearsal footage, providing detailed feedback on specific frames of an actor's performance. Reviewers can pinpoint critical moments, such as emotional beats, line delivery, or physical movements, enabling more targeted and actionable feedback. The system 10 supports multiple annotation types, including text-based comments for direction and performance notes, drawing tools, such as circles, arrows, highlighters, and freeform markup to visually emphasize areas of interest (such as diction, reaction, or eye-line), and inline audio notes for verbal annotation or intonation examples. Additional functionality includes color-coded annotations based on reviewer roles (e.g., casting directors, agents, producers), improving collaboration and feedback prioritization. Reviewers can also apply customizable annotation tags or labels (e.g., “Re-tape,” “Reaction Moment,” “Watch Eye-Line”) to categorize feedback for easy filtering and searching. Layered annotations allow multiple reviewers to add input without overwriting or obscuring each other's notes, with toggles to control visibility by reviewer layer. The system 10 supports interactive comment threads directly linked to specific annotations, which enables reviewers to discuss feedback collaboratively, with the ability to reply, resolve, or escalate comments for final casting decisions. To ensure transparency and compliance, the platform maintains a version history of all annotations, edits, deletions, and replies, with each action time-stamped and linked to the profile of the reviewer. Reviewer tools also include playback speed controls for slow-motion review, frame advance/reverse tools for granular navigation, and the ability to bookmark key moments in the audition or scene for quick reference across collaborators.

The Real-Time Annotation During Virtual Auditions feature enables casting directors and stakeholders to annotate live virtual auditions as they occur. Annotations and feedback can be viewed in real time by authorized participants during the session or immediately afterward. The system 10 also supports post-audition review, allowing additional collaborators to add comments and markup asynchronously. This functionality ensures that feedback is timely, relevant, and accessible to all decision-makers, whether participating live or reviewing afterward.

Role-Based Access Permissions and Secure Storage ensure that only authorized users, such as casting directors, producers, agents, and managers, can access, annotate, or review audition footage and related materials. Audition videos and annotations are stored within secure, encrypted environments, with optional blockchain-based access verification to provide an additional layer of security. The system 10 supports dynamic access control, automatically revoking permissions when a user's role changes or their involvement in a project concludes. These features ensure that sensitive materials remain confidential and accessible only to those with the appropriate permissions.

The system offers a Collaborative Review Environment, supporting multi-user collaboration by allowing multiple stakeholders to review and annotate audition footage simultaneously or asynchronously. It maintains a comprehensive comment and feedback history to ensure transparency throughout the casting and performance review process. This collaborative workflow accelerates decision-making by providing clear documentation of reviewer feedback and streamlining the approval process for casting and production teams.

Use of the video annotation and mark-up tools may vary by user role. Casting Directors may create and manage annotations, approve final reviews, and control access to audition footage. Producers may review and comment on performances, provide final approvals for role selections, and participate in collaborative feedback. Agents or Managers may offer feedback on client auditions and collaborate with actors performance improvement strategies. Optionally, actors may be granted access to reviewer comments if permissions allow. Example, when casting directors choose to share feedback to actor for a callback.

### AI Enhanced Self Tape Auditioning System

### EPIC 10—AI Audition Assistant Main Basis of Claims

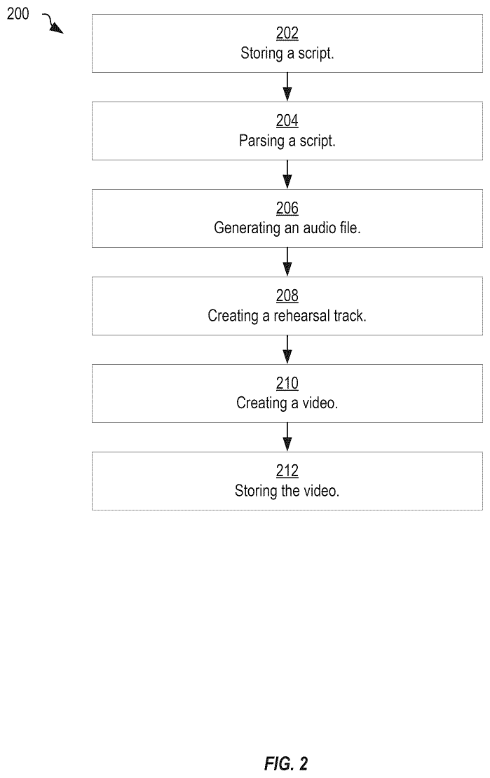

FIG. 2 is a flowchart illustrating a method 200 for managing remote auditions. In embodiments, system 10 provides for an enhanced auditioning system, including virtual or remote auditions. An actor may create a digital audition at any time, from any place, without the need for coordinating with a human reader to perform other characters. System 10 may be implemented on a processor configured to execute computer readable instructions stored on a non-transitory computer readable storage device.

Step 202 includes storing a script. In exemplary step 202, a casting director interacts with casting component 20 to store a script including dialogue to be performed by a first character and a second character in a database on the storage device, which may be database 42A of backend component 40. In embodiments, storing the script includes uploading a digital file of the script and descriptive parameters 24 associated with the first character.

Step 204 includes parsing the script. In an exemplary step 204, the script is parsed by artificial intelligence (AI) model 80 executed by the processor to identify dialogue spoken by the first and second characters. In embodiments, parsing the script includes analyzing the text of the script to identify a script title, scene headings, action, characters, dialogue or parentheticals. In further embodiments, parsing the script may also include identifying dialogue to be performed by a plurality of second characters. In further embodiments, the casting director may review the parsed scrip parsing.

Step 206 includes generating an audio file of the dialogue spoken by the second character. In embodiments, step 206 may include generating a digital representation of the second character. Step 206 may also include generating an audio file of the dialogue spoken by each of the plurality of second characters, if more than one second character is included in the script. Generating the audio file may include text-to-speech technology, for example.

Step 208 includes creating a rehearsal track. In an exemplary step 208, a rehearsal track of the script includes the audio file and silent spaces for adding the dialogue of the first character by an actor. In embodiments, the rehearsal track may include audio files of additional second characters. In further embodiments, the system 10 may automatically generate a notification to one or more actors matching the descriptive parameters when a rehearsal track is created.

Step 210 includes creating a video. In an exemplary step 210, a video of the actor performing the script is created by recording the user speaking the dialogue of the first character over the rehearsal track. In embodiments, the rehearsal track may be played several times before the video is created so the actor may practice the scene. In further embodiments, the system displays dialogue for the first actor when the rehearsal track is played.

Step 212 includes storing the video. In an exemplary step 212, the video representing an audition by the actor is stored in database 42A of backend component 40.

As disclosed herein, the use of a rehearsal track allows an actor to practice and refine a performance multiple times before recording a video audition for storage in system 10. An AI Assistant may be part of AI 80 to facilitate the recording of the video audition. A rehearsal track is created in which the dialogues are neatly organized in a sequence, resembling chapters, perfectly aligned with specific time codes on a scrubber bar. The AI Assistant recites every character's lines, excluding those reserved for the actor. When it is time for the first character to speak, the AI Assistant then falls silent, leaving space for the actor to step in and deliver their dialogue.

An actor may start script rehearsal with default settings by clicking a “Play” button on auditioning platform 66. Alternatively, an actor may customize the AI Assistant by clicking an “Edit” button. Some of the options available in Edit Mode include viewing a list of characters and/or adding a new character, which may include applying an avatar (photo) to a character, entering the character name, selecting a character voice, enabling/disabling the character, specifying whether the character will be voiced by the Actor himself or an AI assistant, or removing the character. Additional editing options include adjusting the speed or line duration of the lines delivered by an AI generated character.

In a default setting, when an actor plays the rehearsal track, the actor sees a video stream of him/herself when delivering lines. When the AI Assistant delivers lines, the actor sees a digital representation of the character delivering the lines. Other information parsed from the script may also be displayed while a rehearsal track is being played, such as actions and sluglines. The AI Assistant may also include the capture of voice-over auditions, which would not include a video stream of the actor.

When the actor is satisfied with the amount of rehearsing, a “Record self tape” button may be clicked to record a video. In embodiments, the actor may hear voices for the other characters, but lines and other information are not displayed while in recording mode. Upon completion, the video representing an actors audition (or self-tape) is uploaded, where it may be accessed by the casting director stored the script or by other users of the system.

### EPIC 12—Representatives and Talent Roster

System 10 may facilitate interactions between agents/managers and actors. An actor can adjust a setting in the profile of the actor to opt in or out or to receive representation requests from agents. Actors may be able to view the profile of an agent and identify agents who specialize in the performance area of the actor and/or have a track record of effectively representing similar talents.

Agents can review a talent roster of actors that they currently represent as well as any pending requests for representation or lists of actors who have opted into receiving representation requests. An agent or manager can browse actor profiles using system 10 and send offers/requests through the system. Agents may also invite actors to create an account on system 10.

### EPICS 13.0 & 13.2—Subscription Plans and Add-Ons

System 10 may provide for different subscription plans and add-on features, also referred to as in-app purchases. One or more subscription plans may be free with a limited set or features. A basic subscription plan may include preloaded scripts, with limited rehearsal and AI assistant capabilities. A user with a Basic plan may be prompted to upgrade to access additional features.

A Starter subscription plan may allow a user to access billing history, select payments methods and cancel a subscription. An actor can upload scripts and perform unlimited rehearsals. A limited number of AI enhanced self-tape auditions may be recorded and uploaded.

Additional resources, such as more script uploads and parsing, and AI self-tape auditions recordings and downloads, may be purchased independently from a subscription. As part of a subscription, users may access a dashboard for selecting additional features for purchase and tracking account balances and related activities.

### EPIC 15—Notifications, Recent/Project Activities

System 10 includes notification features, which may be triggered by user action such as uploading a script or submitting a self-tape. In embodiments, any of the tasks described herein may generate a notification or reminder.

### EPIC 16—Security Iteration

System 10 includes unified security features that enforce trust, transparency, and protection across all platform workflows. These include casting and audition submissions, script and IP licensing via ScriptLink, branded content and product placement management, and royalty distribution and financial transactions, for example. The security architecture is protective, which allows automated, self-enforcing Smart Contracts and licensing agreements to function with legal-grade verifiability.

Core components of the security and compliance portion of system 10 include:
1. AI Witness for chain-of-custody and compliance verification, which provides immutable audit trails for all licensing agreements, royalty payments, and IP transactions, as well as asset submission, licensing approval, contract signing, royalty disbursement that are time-stamped, verified, and logged. The verifications will serve as proof of compliance, critical for dispute resolution, legal enforcement, and regulatory audits.
2. Smart Contract Enforcement with Integrated Security Controls, which automatically enforce licensing terms to include usage rights, territory restrictions, exclusivity clauses, royalty splits, payment triggers, and license revocation. Smart contracts may interact directly with the security infrastructure to provide permission controls that regulate who can execute or modify contracts. Compliance verification ensures that all conditions are met before triggering payments or granting access to IP assets
3. Dynamic Watermarking for IP Asset Protection includes static and dynamic watermarks that may be applied to all scripts, audition videos and branded content. Dynamic watermarks adjust per user, per session, and include identifiers tied to licensing agreements and role permissions, ensuring full traceability of distributed content.
4. Blockchain Ledger for Licensing Agreements & Royalty Transactions. All licensing contracts and royalty payments are recorded on a blockchain ledger, providing tamper-proof records, transparent tracking of IP rights and financial flows, immutable evidence of IP ownership, licensing, and compliance with contract terms
5. Screen Capture Protection and Secure Content Handling. The AI Audition Assistant within the artificial intelligence 80 includes advanced security features that protect scripts (sides), and audition materials shared with actors during the audition process. Features may include anti-screen capture protection with tools that prevent unauthorized screenshots or screen recordings of sensitive materials, including sides/scripts uploaded by casting directors or producers and audition notes and character descriptions. If a screen capture is attempted, then the system can blur sensitive information automatically and log the attempt in an AI Witness audit trail or trigger role-based permission revocation, which cuts off access immediately. Usage controls and conditional access may provide that scripts/sides are only accessible through the AI Audition Assistant for a limited time, or under specific contractual conditions (e.g., after NDA acceptance via Smart Contract). Watermarked previews or dynamic overlays are used to further discourage unauthorized use.

Access to scripts is dynamically revoked if the audition is completed or expired, upon contract withdrawal, or if suspicious activity (e.g., screen capture attempts or IP address mismatches) is detected. Secure content handling may be integrated with AI Witness for compliance so that every access event, download, or interaction with the scripts/sides is logged, time-stamped, and verified by AI Witness. It will Provide immutable proof of who accessed the scripts, when, and under what terms. Role-based access permissions may provide granular control so that access is granted to specific actors, agents, or coaches, based on predefined permissions set by casting directors or producers.
6. Private Storage and VPN Access. Sensitive data and media assets are stored in private Amazon S3 buckets, encrypted in transit and at rest. Role-based access is managed via Smart Contracts, ensuring only licensed parties have access to the appropriate content. Optional VPN requirements add additional security for high-risk transactions, such as high-profile script distribution or brand deal negotiations.
7. Hybrid Decentralized-Centralized Ecosystem. This system serves as the compliance for the hybrid architecture by providing decentralized verification through AI Witness and blockchain. Centralized coordination for user experience, role management, and workflow efficiency. Ensures legal and regulatory compliance across territories and jurisdictions by providing verifiable, auditable records and contract enforcement mechanisms

### Personal AI Witness for Authentic Digital Content

In a digital age marked by manipulation threats such as deepfakes, ensuring content authenticity becomes paramount. System 10 validates real-time authenticity of performances, fortifying trust in the genuineness of content while protecting intellectual property rights. By merging cutting-edge AI technology with continuous monitoring, the Personal AI Witness acts as a digital notary during content creation. As the content takes shape, the AI embeds timestamps, logs vital metadata, identifies anomalies, and generates a “verification record”—a real-time certificate of authenticity. This proactive approach trumps traditional post-creation verification methods, ensuring credibility from the moment of content inception.

System architecture includes features of on-demand activation to empower actors with the ability to activate the AI only during intentional performance capture, Secure data storage that integrates end-to-end encryption, with an exploration into blockchain for enhanced tamper-proofing and an intuitive user interface (UI), will ensure artists can activate and manage recorded data effortlessly. System 10 may be integrated with existing systems to ensure compatibility with standard video recording devices and mainstream platforms for frictionless adoption.

System 10 may include a real-time digital notary presence throughout content creation, instant logging of key metadata and real-time “verification record” generation, personalized AI companions for each creator, which optimizes verification based on individual creation patterns and scalability to cater to various content types—videos, photos, audio, for example.

In embodiments, a representative but non-limiting example of hardware for implementing system 10 will be provided. Compute servers such as AWS EC2 instances may be used for flexibility and scalability as well as GPU instances for AI-related processing. System 10 may also include high-definition cameras that support ONVIF or RTSP standards and edge devices such as Raspberry Pi or NVIDIA Jetson Nano for localized processing. Software Components & Platforms may include Node.js with the Express.js framework for robust API development, React.js with Redux for efficient state management and a modular component structure, PostgreSQL for relational data and MongoDB for unstructured or dynamic data, and Ethereum with Solidity for smart contracts.

Other components that may be included in system 10 include TensorFlow.js or TensorFlow Lite for AI-driven activation (motion detection, scene changes) and Google Cloud Speech-to-Text for voice activation, libsodium or OpenSSL for cryptographic operations, Material-UI with React for a consistent and intuitive interface, WebSockets (socket.io) for real-time updates especially during recording sessions, OpenCV for real-time video processing, TensorFlow/PyTorch trained models for content monitoring, SVG for responsive and clear badge designs, and FFmpeg for dynamic watermarking.

Data Management & Blockchain may be performed by sequelize ORM for PostgreSQL, ensuring data structure consistency, Mongoose for MongoDB, allowing flexibility in data management. pr Web3.js for Ethereum interaction, handling all blockchain operations.
Security: JWT for secure authentication. Regularly run penetration tests using tools such as OWASP ZAP. Implement rate limiters and data validation/sanitization to prevent injection attacks.

EPIC 10 page 9—Watermarks (dynamic—user ID, static—company logo) as a branding element and indicator of content ownership are displayed on the script content in the preview and edit mode.

### AI Enhanced Self Tape Auditioning System

Several technologies may be used in system 10. Representative examples for purposes of illustration are discussed below but others may be included.
Speech Synthesis & NLP: Enables the AI to deliver lines with context, emotion, pauses, and tonal variations for realistic performance interactions.
Video Recording & Processing: Utilizes the device's camera and microphone for capturing high-quality video and audio.
Editing Tools: Provides algorithms for editing, trimming, and enhancing video recordings.
Decentralized Computing: Supports decentralized CPU and GPU processing using Akash and RNDR for scalability and high-performance AI processing.

Script Input, Parsing & Preparation may use technologies such as:
Format Acceptance: Compatible with PDF, DOC, TXT, and other formats for seamless dialogue extraction.
Character Identification: Automatically tags characters and their lines while allowing manual edits to adjust assignments.

Taping with an AI Co-Actor may include:
Recording Interface: Intuitive UI displaying the script alongside the actor's video feed.
AI Line Prompting: Delivers opposing lines in real-time with visual cues (e.g., progress bars) to guide timing.
Multiple Takes: Enables multiple attempts for each scene, storing all takes for review and selection.

Voice & Tone Customization for an AI Co-Actor may use:
Voice Profiles: Offers a library of diverse voices, accents, and age ranges for flexibility.
Tone & Emotion Modulation: Allows actors to specify the desired tone, speed, and emotional delivery for AI-generated lines.

A Video Editing Suite includes features of:
Clip Trimming: Trim the start and end points of clips with precision.
Merging Clips: Combine multiple takes and angles seamlessly into a single video.
Audio Adjustments: Control the AI co-actor's volume, add background music, and integrate sound effects.
Basic Video Effects: Add filters, adjust brightness/contrast, and enhance visual quality.

Interactive Playback & Review functions include:
Scene Selection: Jump to specific lines or scenes during playback for easier review.
Feedback Integration: Mark sections to modify tone, pacing, or emotion for future takes.

Export & Sharing Features include:
File Formatting: Export in MP4, MOV, and other popular formats.
Compression Tools: Reduce file size for faster uploads without compromising quality.
Direct Sharing: Email self-tapes, generate download links, or upload directly to file sharing platforms.

Other features may include:
Emotion Recognition AI: Analyzes actor's facial expressions to provide feedback or adapt the AI co-actor's responses dynamically.
Voice Recognition Commands: Allows actors to control playback, pauses, and line delivery using voice commands.
AI Speech Variety (WaveNet Integration): Uses WaveNet models for natural-sounding dialogue delivery with varied tones and accents.
Dialogflow AI Integration: Incorporates voice-activated prompts to ensure responsive interactions during rehearsals.
Blockchain Verification Tools (AI Witness): Embeds timestamps and hash values to protect video authenticity and intellectual property.
zkML Encryption (Zero-Knowledge Machine Learning): Ensures privacy-preserving AI computations while maintaining performance and scalability.
Multi-Angle Recording Options: Supports multi-camera inputs for capturing different angles and perspectives.
Green Screen Compatibility: Allows actors to record with virtual backdrops for professional-quality self-tapes.

### ScriptLink Entertainment Marketplace

ScriptLink Entertainment is a hybrid blockchain and AI-powered platform designed to address key challenges in product placement, brand advertising, and intellectual property (IP) protection in the entertainment industry. By combining decentralized blockchain technology for IP protection and centralized management of brand contracts, ScriptLink offers a streamlined, secure, and transparent environment where content creators, studios, advertisers, and brands can collaborate efficiently.

The platform leverages AI-driven insights and a dual-layer model to solve common pain points, such as IP theft, inefficient product placement, and the lack of organic brand integration in creative works. ScriptLink ensures that brands are integrated seamlessly into content, while creators benefit from secure IP registration and monetization opportunities through the marketplace.

Independent creators face difficulties protecting their intellectual property. Current solutions are costly and inefficient, leaving works vulnerable to theft and unauthorized use, especially in the digital age where content is easily duplicated. Product placement today is often disjointed and manual, leading to mismatched and non-organic placements that disrupt the storyline and fail to serve both the creators and the brands effectively. Small creators struggle to secure monetization opportunities due to a lack of connections with advertisers, leaving them with fewer resources than large studios. Ambiguities and the absence of clear legal frameworks in product placement or licensing deals often lead to disputes and payment delays, complicating collaboration between brands, creators, and production companies.

At its core, ScriptLink uses blockchain technology to offer creators secure, decentralized storage for their scripts, concepts, and other creative assets. By timestamping these works and leveraging smart contracts, ScriptLink ensures immutability and transparency, preventing IP theft and enabling frictionless licensing deals.

Creators and studios can register their IP assets on the ScriptLink blockchain, providing indisputable proof of ownership and simplifying licensing agreements with brands and advertisers.

ScriptLink integrates AI-driven product placement algorithms to analyze scripts and identify organic brand placement opportunities. Advertisers can find matches based on the context, target demographics, emotional tone, and cultural relevance, ensuring seamless and natural integration of their products into creative works.

Creators submit their scripts to the platform. Using AI, the system scans the script to identify moments where brands can be integrated, such as a coffee shop scene for a coffee brand or a tech product used by a character. The system then matches these opportunities with advertisers registered on the platform, ensuring authentic placements. ScriptLink goes beyond keyword or genre-based placements, offering contextual analysis that matches brands based on narrative elements, emotional arcs, and audience engagement metrics, which makes for a more natural integration of brands into stories.

The ScriptLink Marketplace allows content creators to upload projects, and brands can browse and bid on product placement opportunities. Creators can monetize their projects even before production starts, while brands benefit from AI-driven insights like audience demographics and genre-specific trends. Independent creators can secure advertising deals, ensuring they can fund their projects without relying on intermediaries.

ScriptLink uses blockchain-based smart contracts to automate payment, ensure legal compliance, and contract transparency. These smart contracts clearly outline the terms of product placement deals and licensing agreements, triggering automated payments once the conditions are fulfilled. The AI Witness feature monitors product placement agreements and provides real-time proof of compliance or non-compliance, helping to avoid legal disputes and costly interventions.

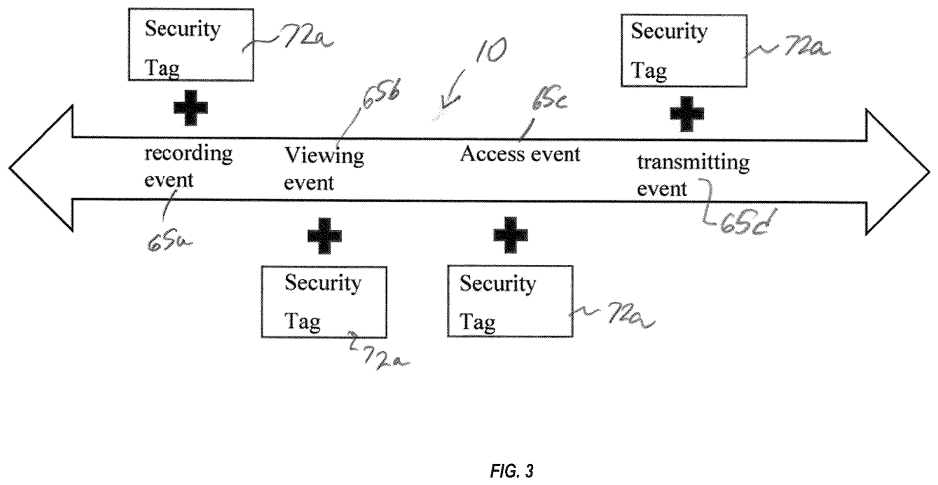

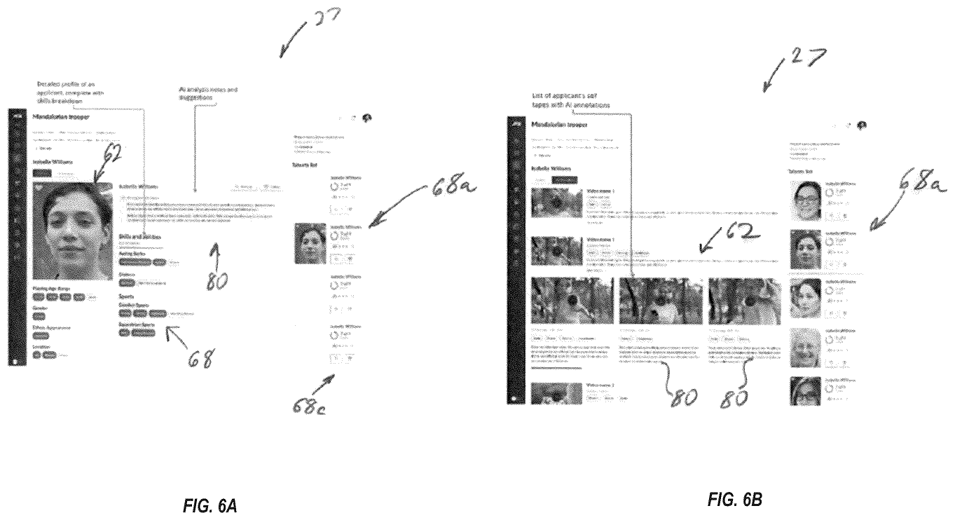

FIG. 3 shows one embodiment of authentication of data performed by system 10. Each event in the actor component 60 is accompanied by a verification element 72a, which may be a tag, a code or a certificate, that is generated using a random generator and is attached to each event. For example, the event of opening actor's dashboard 67 (FIGS. 6A and 6B) receives a verification element 72a. The acts of reviewing 65a, recording 65b and auditioning 65c, will each have their own verification elements 72a, which may be augmented by additional verification elements 72a for events that occur over time, like an audition, or a training. Each verification element 72a is then stored separately in database 42.

The data may be matched by random codes, time stamps or by association with events related to the particular data through a specific sequential occurrence to that data, or a combination of such factors. Thus, for example, if a specific recording event 65a was five minutes long and is followed by a narrator event, or a change of scenes event, all of which had a verification element 72a assigned the verification elements 72a would be aware of preceding and following events occurring during a recording. An act of tampering would be detected due to a mismatch or missing verification elements 72a, or elements occurring out of sequence. This is just one embodiment of verification, and other or different verification methods may be implemented. Data authentication of computer application 10 is further configured to detect differences in performance by an actor, which may indicate impersonation.

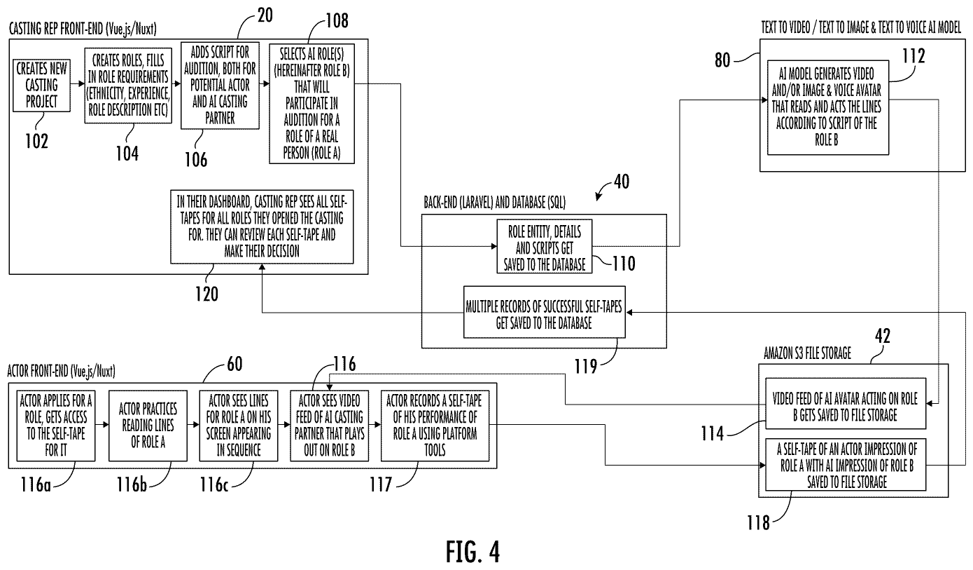

FIG. 4 provides a high-level diagram that demonstrates one embodiment in which system 10 enables the method of recruitment of talent to fill open positions in the sector of entertainment and performing art, where talent can audition remotely with the assistance of artificial intelligence component 80.

The process begins when a publisher, who may be a casting producer, a head entertainer, etc., creates a casting project in step 102. The publisher then defines one or plurality of casting roles 22. Here, the backend 40 may already be publishing the available roles to actors/entertainers, prompting an actor to apply for a role using the actor component 60 in step 116a. In the application step 116a, the actor may create a self-tape of personal data or may present personal data as separate entries.

The publisher creates or registers the script, for each casting role and the artificial intelligence component 80 to function as casting partner, additional partner, narrator, multiple characters, sound effects, contextual effects producer, etc. The publisher can then configure what partner role should be performed by the artificial intelligence component 80 in step 108. The basic script is then transferred to the backend portion 40, where the role and its details, together with scripts and function of the action of the artificial intelligence component (80) for each individual casting role 22 are stored as a database entry in step 110. It should be noted that each individual feature may be recorded separately and then assembled into features by one casting role using the data dictionary that may be configured using the artificial intelligence component 80. Thus, for example, the casting role 22 will be one database entry. The script for this casting role 22, as another database entry, the role played by artificial intelligence component 80 is a separate entry. Sound effects or visual effects to be played with the role as a separate database entry. All of these entries are then assembled based on data dictionary for this casting role 22. These database entries may then be reused by the backend component 40 as a library of past roles and casting parameters for future roles and auditions.

The artificial intelligence component 80 proceeds to generate a video, voice recording and other details of presenting the script that an actor will see or hear as video or an audio avatar in step 112. The video created in step 112 by the artificial intelligence component 80 is then further stored in the library of roles for a track record and as part of a library for future references.

In the meantime, within the actor component 60, the actor is given the auditioning platform 66 to practice his/her lines or act in step 116b and can practice using the lines of the script presented by artificial intelligence component 80 on the screen of the auditioning platform 66.

Notably, the artificial intelligence component 80 may be configured to train the actor in steps 116b and 116, for example, by removing lines that the actor has read very fluently and without the slight pause required to read a line. Using this method, as the presentation by the actor becomes more polished and fluid, the lines will keep disappearing off the screen, until the actor is ready to record an audition recording 117 together with artificial intelligence component 80 serving as the audition partner. It should be noted further that the training period may be a factor recorded by the artificial intelligence component 80 to be considered by the publisher. The audition tape is then recorded in database 42 of the backend portion 40 and then presented to dashboard 27 by the publisher's review of the audit and actor data in step 120.

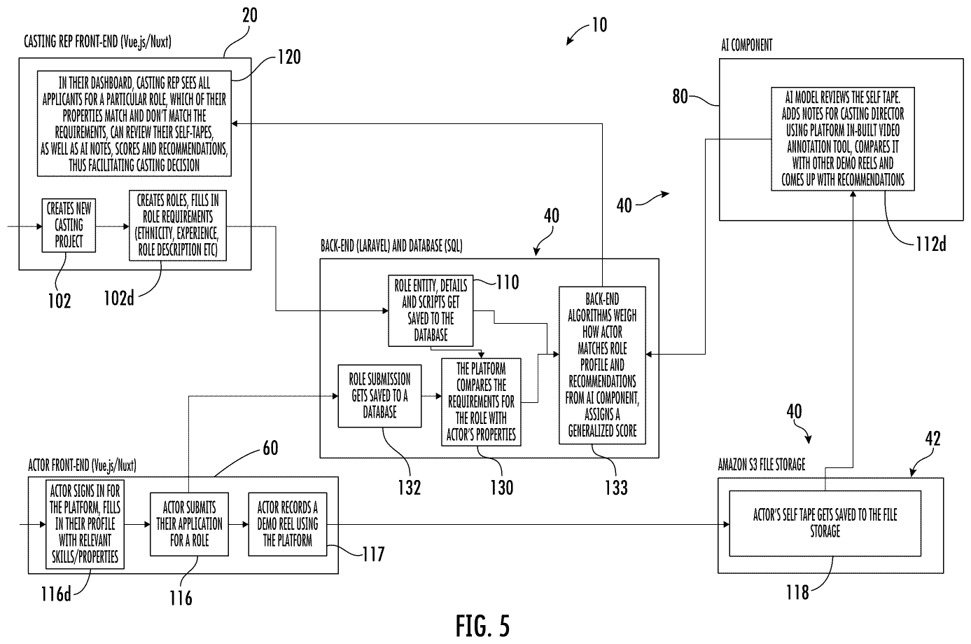

FIG. 5 is an additional diagram of the method disclosed in FIG. 4. At the actor component 20 of the computer application 10, the step 102 of creating a casting project may additionally comprise the step of defining criteria for casing project in step 102d. For example, in the step 102 of defining criteria, the publisher may fill in additional role requirements, such as ethnicity, age, experience, role description, size, weight, sex, etc. These criteria, along with the casting role 22 are then recorded in the database 42 of the backend component 40 in step 110. At the same time, the role is presented to an actor/performer in step 116a in the actor portion 60. The actor portion 60 or the backend portion 40 may be configured to present the casting role 22 being described in the present figure due to the criteria defined by the for preferred roles sought in step 116d. The actor then submits an application for the role in step 116, which now contains actor data with actor defined criteria for the role along with standard actor's data, such as name, age, sex, ethnicity, experience, residency, etc. Using the actors dashboard 67 having an artificial intelligence 20 component 80 playing as an auditioning partner, the actor creates an audition recording in step 117 which is then recorded in the database 42 of the backend portion 40. In the embodiment described in FIG. 4, the artificial intelligence component 80 receives and reviews the recording created in step 117 and compares it against a paradigm or evaluates the recording for important elements in step 112d. The artificial intelligence component 80 may at this point check security features to ensure data integrity of the recording. Based on its finding in step 112d, the artificial intelligence component 80 issues a recommendation, which is then provided to a human evaluation in the backend component 40, or to a further algorithm enabled by artificial intelligence component 80. Here, the artificial intelligence component 80 retrieves, in step 132, the actor data comprising the actor defined criteria in step 116d and the application created by the actor's application in step 116. The artificial intelligence component 80 retrieves the casting role, criteria and other details defined by the publisher and that were recorded in step 110. The artificial intelligence component 80 then compares in step 130 the publisher criteria provided in step 102d with actor defined criteria from step 116d and further merges in step 133 the recommendation based on such comparison from step 130 with recommendations made in step 112d of audition data and displays its recommendation on the dashboard 27 in step 120.

FIGS. 6A and 6B demonstrate a dashboard 27 showing the actor data 68 and audition data 62. A plurality of additional applicants are provided as a sidebar 68c. Recommendation or assessment of artificial intelligence component 80 is additionally visible next to the audition data 62.

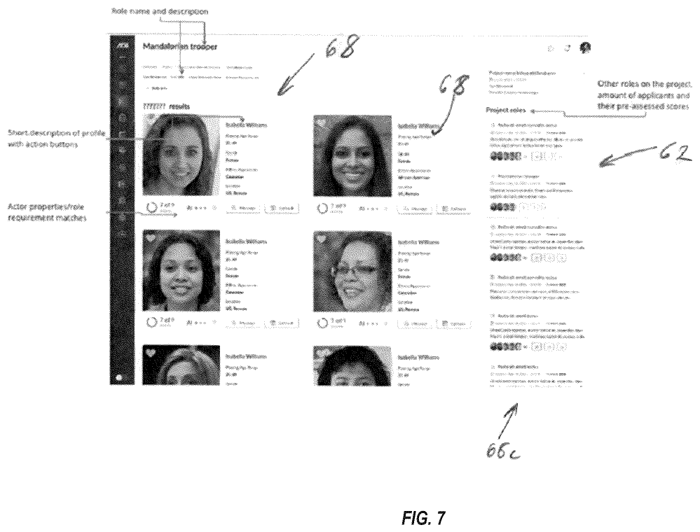

FIG. 7 demonstrates a library feature of the backend portion 40 that is displayed in the casting portion 20 or to via the audition platform 67 of actor portion 60. Shown are a plurality of actor data 68 featuring data of the applicants, or prior hires. The link to audition data 62 is provided in the sidebar 68c, or as an individual link with each actor data 68.

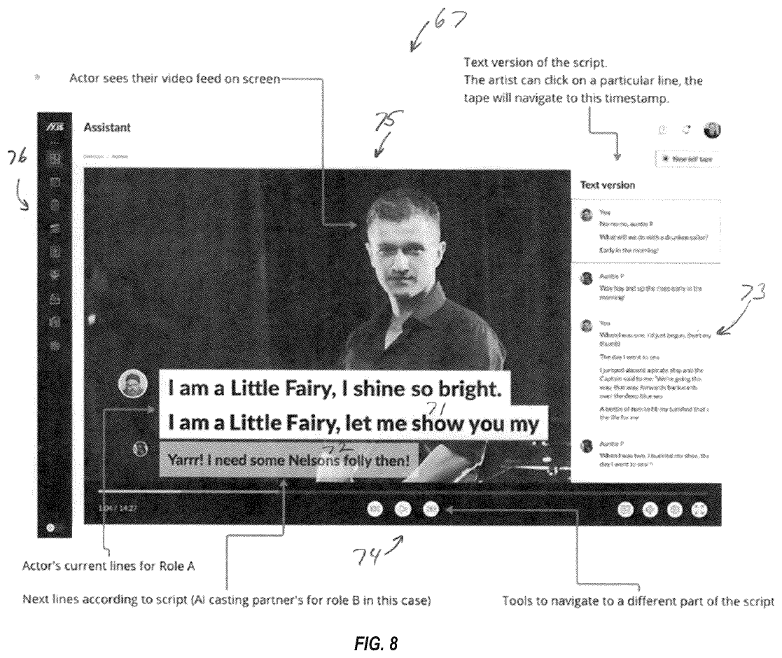

FIG. 8 is a demonstration of audition platform 67. Artificial intelligence component 80 records the image of the actor and displays the image in real time via screen 75. In this way, the actor obtains an immediate feedback on how they appear while performing the particular scene. The sidebar 73 permits the Actor to scroll to a particular scene or a set of lines and record items out of sequence, or pause an existing audition to review a prior or future scene. An additional sidebar 76 may provide additional control and editing tool for the actor. During performance, the actor can view the role lines 71 they are supposed to recite and also view and hear the lines recited by the role or roles played by artificial intelligence component 80. The artificial intelligence component 80 may display the avatar representing the role it is playing via screen 75. The actor/performer can then record the entries using the audition/video control interface 74.

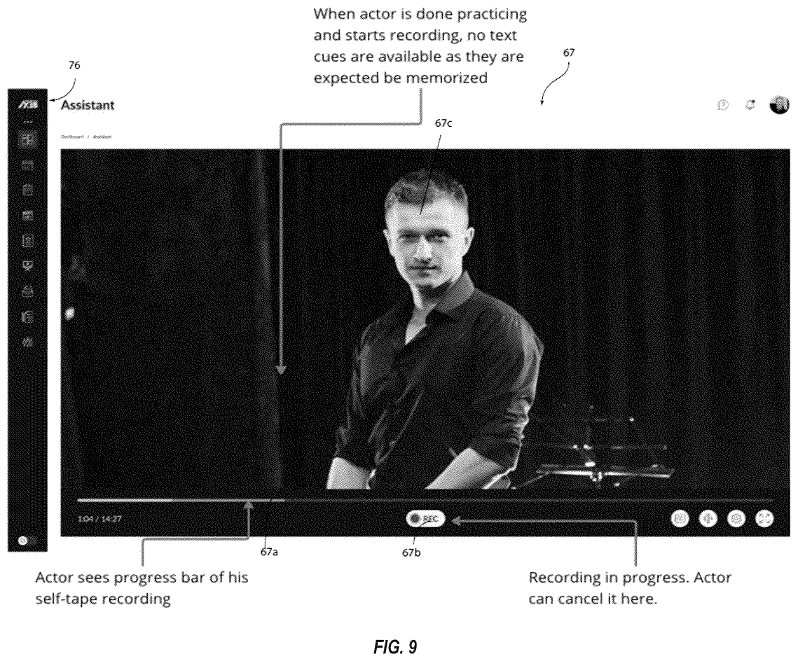

FIG. 9 demonstrates the audition platform 67, when the performer is actually recording the audition, or when the artificial intelligence component 80 determined that the actor is ready to proceed, or when the actor, based on criteria (24) set by publisher is required to proceed. The role lines 71 disappear partially or completely and the recording 67b begins. It is preferable that the recording 67b would become indelible either upon recording, or upon several tries, depending on the settings provided to artificial intelligence component 80 by the publisher. The Actor can see himself or the co-role played by the artificial intelligence component 80 as image 67c. A plurality of collaboration, editing or communication tools are available to the actor depending on security settings enforced by artificial intelligence component 80, via the sidebar 76.

Although this invention has been described with a certain degree of particularity, it is to be understood that the present disclosure has been made only by way of illustration and that numerous changes in the details of construction and arrangement of parts may be resorted to without departing from the spirit and the scope of the invention. While various inventive aspects, concepts and features of the inventions may be described and illustrated herein as embodied in combination in the exemplary embodiments, these various aspects, concepts and features may be used in many alternative embodiments, either individually or in various combinations and subcombinations thereof. Unless expressly excluded herein all such combinations and subcombinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims, as currently written or as amended or added in the future. Descriptions of exemplary methods or processes are not limited to inclusion of all steps as being required in all cases, nor is the order that the steps are presented to be construed as required or necessary unless expressly so stated.

What is claimed:

1. A system for managing remote auditions, comprising:
a non-transitory computer readable storage device configured to store computer readable instructions; and
a processor configured to execute the computer readable instructions to cause the computer system to perform operations comprising:
storing a script including dialogue to be performed by a first character and a second character in a database on the storage device;
parsing the script, by an artificial intelligence (AI) model executed by the processor, to identify dialogue spoken by the first character and the second character;
generating an audio file of the dialogue spoken by the second character;
creating a rehearsal track of the script including the audio file and silent spaces for adding the dialogue of the first character by an actor;
creating a video of the actor performing the script by recording the user speaking the dialogue of the first character over the rehearsal track; and
storing the video in the database.

2. The system of claim 1, wherein the processor is configured to execute the computer readable instructions to cause the computer system to perform further operations comprising displaying a list of videos created by different actors using the same rehearsal track on a dashboard for selection by a user.

3. The system of claim 1, wherein the processor is configured to execute the computer readable instructions to cause the computer system to perform further operations generating a digital representation of the second character.

4. The system of claim 3, wherein the script includes dialogue to be performed by a plurality of second characters.

5. The system of claim 4, wherein the processor is configured to execute the computer readable instructions to cause the computer system to perform further operations comprising generating an audio file of the dialogue spoken by each of the plurality of second characters.

6. The system of claim 1, wherein storing the script further comprises uploading a digital file of the script and descriptive parameters associated with the first character.

7. The system of claim 6, wherein the system automatically generates a notification to at least one actor matching the descriptive parameters when a rehearsal track is created.

8. The system of claim 1, wherein parsing the script further comprises analyzing the text of the script to identify at least one of a script title, scene headings, action, characters, dialogue and parentheticals.

9. The system of claim 1, wherein the processor is further configured to execute the computer readable instructions to cause the computer system to perform further operations comprising, after the rehearsal track is created, playing the rehearsal track a plurality of times before the video is created.

10. The system of claim 9, wherein the system displays dialogue for the first actor when the rehearsal track is played.

11. The system of claim 1, wherein creating the video further comprises embedding a dynamic watermark in the video.

12. The system of claim 11, wherein the dynamic watermark includes at least one of a username, a timestamp and a session identifier.

13. The system of claim 11, wherein storing the video in the database further comprises storing the dynamic watermark on a blockchain.

14. The system of claim 1, wherein storing the script in the database further comprises storing metadata associated with the script on a blockchain.
